(19) United States
(12) Patent Application Publication
(10) Pub. No.: US 2013/0202167 A1
(43) Pub. Date: Aug. 8, 2013

(54) METHOD AND APPARATUS FOR GENERATING GENE EXPRESSION PROFILE

(71) Applicant: Jung-joon LEE, Seoul (KR)

(72) Inventor: Jung-joon LEE, Seoul (KR)

(73) Assignee: SAMSUNG ELECTRONICS CO., LTD., Suwon-si (KR)

(21) Appl. No.: 13/604,389

(22) Filed: Sep. 5, 2012

(30) Foreign Application Priority Data
Feb. 2, 2012 (KR) 10-2012-0010846

(51) Int. Cl. G06K 9/62

(52) U.S. Cl. 382/129

(57) ABSTRACT

A method and apparatus for generating a gene expression profile by obtaining data relating to phenotypes and data relating to gene expression from biological samples and statistically analyzing them together.

### CROSS-REFERENCE TO RELATED APPLICATIONS

This application claims the benefit of Korean Patent Application No. 10-2012-0010846, filed on Feb. 2, 2012, in the Korean Intellectual Property Office, the disclosure of which is incorporated by reference herein in its entirety.

### BACKGROUND

1. Field

The present disclosure relates to methods and apparatuses for generating gene expression profiles.

2. Description of the Related Art

Since deoxyribonucleic acid (DNA), a nucleic acid, has been found, technologies for analyzing genes in a biological sample, such as a patient's cell, have continuously been developing. Thus, it is generally known that gene expression patterns under different experimental conditions for genes of which biological functions are similar or of which biological interrelatedness is high appear similar. By using such a fact and measuring gene expression levels of genes in the biological sample under variations of various experimental conditions, gene expression profiles can be obtained. The gene expression profiles have especially been used to understand a gene expression level or a gene expression pattern of a cell in developing a new medicine or treating a disease of a patient.

However, as described earlier, since it has been assumed that phenotypes in a biological sample perturbed by the new medicine or a medicine for the treatment of a disease are typically the same, the gene expression profiles obtained so far are not deemed to have reflected exact results of the gene expression.

### SUMMARY

Provided are methods and apparatuses for generating a gene expression profile. Additional aspects are set forth in part in the description which follows and in part are apparent from the description, or may be learned by practice of the presented embodiments.

According to an aspect of the present invention, there is provided a method of generating a gene expression profile, the method comprising receiving imaging results of perturbing biological samples with a predetermined condition and imaging results of hybridizing nucleic acids contained in the biological samples with nucleic acid probes; classifying each of the perturbed biological samples into phenotype subgroups according to the imaging results of the perturbed biological samples; analyzing gene expression data for each of the perturbed biological samples based on the imaging results of the hybridization; and generating a gene expression profile using the analyzed gene expression data and a distribution of the classified phenotype subgroups.

In a related aspect, a method of generating a gene expression profile, the method comprising perturbing biological samples with a predetermined condition and imaging the perturbed biological sample; hybridizing nucleic acids contained in the biological samples with nucleic acid probes; classifying the perturbed biological samples into phenotype subgroups according to the imaging results of the perturbed biological samples; analyzing gene expression data of the perturbed biological samples based on the hybridization of the nucleic acids of biological samples with the probes; and generating a gene expression profile using the analyzed gene expression data and a distribution of the classified subgroups.

The gene expression profile may include information about how the phenotypes corresponding to the classified phenotype subgroups affect the gene expression data.

The gene expression profile may be generated by statistically estimating gene expression levels that correspond to the classified phenotype subgroups for each of the biological samples.

The method may further include calculating distribution ratios of the classified phenotype subgroups for each of the biological samples; calculating the gene expression levels from the analyzed gene expression data for each of the biological samples; and estimating a correlation between the distribution ratios and the gene expression levels for the biological samples, wherein the generating of the gene expression profile is based on the estimated correlation.

The imaging results of the hybridization include results of hybridizing the nucleic acids of the biological samples with probes by contacting the nucleic acids of the biological sample with a microarray containing the probes. The microarray can be analyzed, and the results obtained, by imaging the microarray.

The biological samples may include multiple samples of the same type (e.g., containing the same cell type). In this case, it may be useful to perturb the multiple samples using different conditions. Alternatively, the multiple samples may include different types of samples (e.g., containing different types of cells). In this case, it may be useful to perturb the different cell types with the same condition(s).

The phenotype or phenotypes of the samples can be determined by detecting predetermined phenotypic markers, and the samples classified according to phenotype, by applying a predetermined classification algorithm to each of the received imaging results of perturbing the biological samples.

The perturbed cells can be imaged to determine the effects of the perturbing condition on the phenotype of the cells. The imaging results of the perturbing may be based on image data obtained by using High Content Cell Imaging. Alternatively, or in addition, the imaging results of the perturbing may comprise light intensities of fluorescent materials used to label the biological samples, and obtained from the image data.

According to another aspect of the present invention, there is provided a non-transitory computer-readable recording medium having computer executable programs recorded thereon for carrying out the method of generating a gene expression profile.

According to another aspect of the present invention, there is provided an apparatus for generating a gene expression profile, the apparatus including: a data receiving unit for receiving imaging results of perturbed biological samples using a predetermined condition and receiving imaging results of hybridizing nucleic acids in the biological samples with nucleic acid probes; a phenotype analyzing unit for classifying the perturbed biological samples into phenotype subgroups according to the imaging results of the perturbed biological samples; a gene expression analyzing unit for analyzing gene expression data for each of the biological samples based on the imaging results of the hybridization; and a profile generating unit for generating a gene expression profile using the analyzed gene expression data and a distribution of the classified phenotype subgroups.

The generated gene expression profile may include information about how the phenotypes corresponding to the classified phenotype subgroups affect or correlate with the gene expression data.

The profile generating unit may generate the gene expression profile by statistically calculating or estimating gene expression levels that correspond to the classified phenotype subgroups for the biological samples.

The phenotype analyzing unit may calculate distribution ratios of the classified phenotype subgroups for each of the biological samples, wherein the gene expression analyzing unit calculates the gene expression levels from the analyzed gene expression data for each of the biological samples, and wherein the profile generating unit generates the gene expression profile based on the result of statistically calculating or estimating a correlation between the distribution ratios and the gene expression levels, for the biological samples.

The received imaging results of the hybridizing may come from micro-arrays having the probes.

The biological samples may include multiple samples comprising the same type of cell.

The phenotype analyzing unit may classify the phenotypes into the phenotype subgroups by applying a predetermined classification algorithm to each of the received imaging results of the perturbed biological samples.

The imaging results of the perturbed biological samples may be based on image data obtained by using High Content Cell Imaging.

The imaging results of the perturbed biological samples may be light intensities of fluorescent materials used to label the perturbed biological samples, optionally obtained from image data.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram of a system for generating a gene expression profile, according to an embodiment;

FIG. 2 is a detailed block diagram of an apparatus for generating the gene expression profile, according to an embodiment;

FIG. 3 illustrates a process of generating the gene expression profile, according to an embodiment; and

FIG. 4 is a flowchart of a method of generating a gene expression profile, according to an embodiment.

### DETAILED DESCRIPTION

Reference will now be made in detail to embodiments, examples of which are illustrated in the accompanying drawings, where like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

FIG. 1 is a diagram of a system for generating a gene expression profile, according to an embodiment. Referring to FIG. 1, the system includes an apparatus 10 for generating a gene expression profile, a cell culture dish A (referred to as Well A) 21, a cell culture dish B (referred to as Well B) 22, a micro-array A 31 and a micro-array B 32. One of ordinary skill in the art would appreciate that although, for convenience of explanation, there are two cell culture dishes and two micro-arrays shown in this embodiment, the number of dishes and micro-arrays is not limited thereto and may vary depending on circumstances of the system. In addition to the cell culture dishes and the micro-arrays, other devices for measuring gene expression levels or phenotypes in biological samples 101 and 102 may be used.

Further, only components relevant to the embodiment are shown in the system of FIG. 1 to avoid obscuring features of the embodiment. However, other general components than those illustrated in FIG. 1 may further be included.

Referring to FIG. 1, the apparatus 10 is configured to obtain a gene expression profile from the given biological samples 101 and 102. Here, the biological samples 101 and 102 include, for example, animal cells, tissues, serum samples, etc.

A nucleic acid, for example Deoxyribonucleic Acid (DNA), corresponds to a genetic material, that is, a gene containing hereditary information of an organism. Nucleic acids comprise a nucleic acid sequence, which encodes information about cells, tissues, etc. that make up an organism, and the nucleic acid bases establishing the sequence represent information about a connecting order or an arranging order of 20 types of amino acids as constituents of a protein query of the organism. Thus, making the nucleic acid sequence, i.e., a gene, represent a specific genetic character is determined from information of the bases contained in the nucleic acid sequence.

As such, various bionic information of a human is represented by nucleic acid sequences. Accordingly, much research into information about complete nucleic acid sequences of an individual has been done in many fields, such as, understanding of the phenomenon of life, development of new medicines, diagnosis and prevention of diseases, researches into human genes, etc.

Such information of the nucleic acid sequences of an individual contains information relating to diseases from past to future. In particular, it has been known that many diseases are caused by a difference between gene expression levels due to a change in the number of copies of a gene or a change in transcription levels of the gene. For example, the change in gene expression levels of a specific gene (e.g., a tumor gene or a tumor suppressor gene) helps to catch an existence and development of various diseases.

Compounds such as drugs used as a cure for such diseases (e.g., cancers) may affect a portion of, or the entire, gene expression levels. Hence, measuring of the change in the gene expression levels may be considered as part of a method of monitoring or predicting the effect of the cure, like a medicine. Therefore, if information about the gene expression levels associated with an individual's nucleic acid sequence may be exactly obtained, development of a new medicine, prevention or optimum treatment of a disease may be determined in the early stage of the disease.

For analyzing the gene expression levels, the micro-arrays 31 and 32 are used. For example, as described herein, the micro-arrays 31 and 32 may be used to confirm the gene expression levels for predicting susceptibility to a specific medicine.

When contacting the biological samples 101 and 102 to be analyzed with probes in the micro-arrays, the micro-arrays 31 and 32 provide results of hybridizing nucleic acids in the biological samples 101 and 102 with hundreds or hundreds of thousands of probes on the plates of the micro-arrays 31 and 32. When a reaction occurs between the biological samples 101 and 102 and the probes, different degrees of hybridization are expressed depending on complementary degrees between the biological samples 101 and 102 and the probe materials. Here, a fluorescent signal is used for estimating the degrees of hybridization. The biological samples 101 and 102 (or nucleic acids isolated from the samples) labeled with a fluorescent material are put into reaction with the micro-arrays 31 and 32, respectively, and then excitation light is applied to the fluorescent material. Then, the fluorescent signal is detected by radiation emitted from the fluorescent material. The intensity of the detected fluorescent signal is converted into numerical data, which is in turn analyzed to obtain such gene expression levels of the biological samples 101 and 102.

In the embodiment, the micro-array A 31 obtains the gene expression levels of the biological sample A 101, and the micro-array B 32 obtains the gene expression levels of the biological sample B 102.

In the past, it was assumed that when information about such gene expression levels is obtained with the micro-arrays 31 and 32, gene expression profiles of the biological samples 101 and 102 of the same cells, the same tissues, etc. are the same. However, in practice, even with the biological samples 101 and 102 of the same cells, the same tissues, etc., the gene expression levels have significant deviations, thus possibly leading to large deviations in phenotype levels.

For example, in an experiment of measuring drug efficacy, if measurement of the gene expression levels is conducted while increasing the amount of drug doses, one may conclude that the gene expression levels do not increase proportional to the amount of drug doses, but gene expression levels of a specific gene that corresponds to a sub-population of various phenotypes in the biological samples 101 and 102 not responsive to the drug increase.

In other words, with traditional methods, it is difficult, if not impossible, to obtain exact gene expression profiles by using the micro-arrays 31 and 32 to obtain information about, for example, gene expression levels. However, the apparatus 10 for generating a gene expression profile according to the present embodiment classifies phenotypes in biological samples into sub-groups in advance or simultaneously with genetic profiling according to predetermined criteria, and obtains the gene expression profile based on the classified sub-groups, thus resolving an error that occurs traditionally. Operation of the apparatus 10 for generating a gene expression profile according to the present embodiment will now be explained.

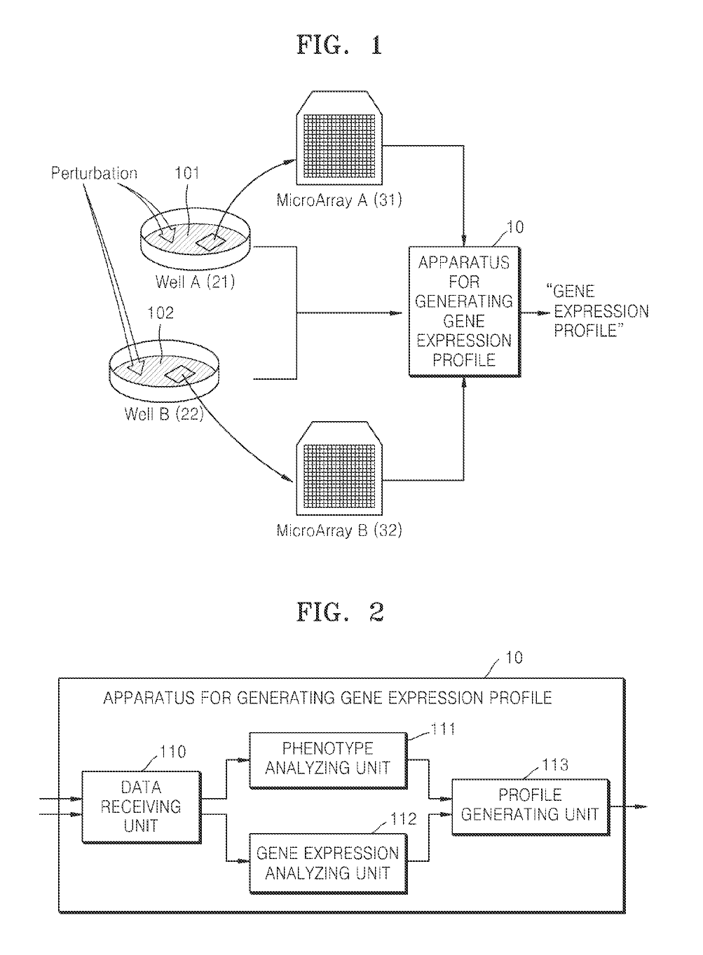

FIG. 2 is a block diagram of the apparatus 10 according to an embodiment of the present invention. Referring to FIG. 2, the apparatus 10 includes a data receiving unit 110, a phenotype analyzing unit 111, a gene expression analyzing unit 112, and a profile generating unit 113.

The data receiving unit 110, the phenotype analyzing unit 111, the gene expression analyzing unit 112, and the profile generating unit 113 may be implemented with general-purpose processors. The processor may be implemented with a number of arrays of logic gates, or in a combination of general-purpose microprocessors and memories having programs stored therein, executable by the microprocessors. Furthermore, one of ordinary skill in the art would understand that they may be implemented with other types of hardware and/or software.

To avoid obscuring features of the present embodiment, FIG. 2 only shows some hardware components as needed to illustrate and explain the present embodiment. However, one of ordinary skill in the art will understand that other general components other than those illustrated in FIG. 2 may further be included.

The data receiving unit 110 receives results of perturbing the biological samples A 101 and B 102 with a predetermined condition from the wells A 21 and B 22. The data receiving unit 110 further receives results of hybridizing the biological samples A 101 and B 102 with probes in the micro-arrays A 31 and B 32 from the micro-arrays A 31 and B 32.

First, an explanation of the results of the perturbation received is as follows:

As discussed above, the biological samples 101 and 102 contained in well A 21 and well B 22 are perturbed using the predetermined condition, e.g., application to the sample of a particular compound or a particular medicine, or other treatment. Here, the term ‘perturbation’ refers to pharmacological treatment using drugs, chemical compounds, toxins, synthetic products or natural products, physiological treatment using insulin, hormones, steroids or peptides, environmental treatment using change in temperature, x-rays or pressure, genetic treatment using microRNAs, siRNAs, mutations or genetic insertions and deletions, etc.

After the perturbation of the biological samples 101 and 102 contained in well A 21 and well B 22, the samples are analyzed for phenotypic changes by imaging or otherwise detecting phenotypic markers. For instance, image data that represents each of the phenotypes in each of the biological samples 101 and 102 can be obtained using a microscope, such as a fluorescence microscope, a bright field microscope, or a differential interference contrast microscope. High Content Cell Imaging is one technology already known in the art that can be employed for this purpose. In another embodiment, the biological samples 101 and 102 are labeled with different dyes or other detectable labels (e.g., fluorescent labels, radiolabels, etc.) that can be used to detect phenotypic markers, before or after applying the perturbing condition to the sample, and the phenotypes can be detected on the basis of the dyes or other detectable labels in the perturbed samples, optionally using imaging results or data obtained with the microscope. The data receiving unit 110 receives the image data.

The phenotype analyzing unit 111 classifies each of the phenotypes in the biological samples 101 and 102 according to the perturbation results received from the data receiving unit 110 into at least one subgroup.

More specifically, each phenotype in the biological samples 101 and 102 may be obtained in the form of various numerical data from the image data received from the data receiving unit 110. For instance, the fluorescence microscope measures various fluorescence intensities according to the labeling dyes after the perturbation of the biological samples 101 and 102 and the measured intensities are reflected intact in the image data. Thus, the phenotypes in the biological samples 101 and 102 have different numerical values in a multidimensional plane or space according to a degree of phenotype expression. Other imaging techniques can similarly be used to determine and represent phenotypes as numerical data.

The phenotype analyzing unit 111 uses a predetermined classification algorithm to classify the various numerical data that represents the phenotypes into subgroups. According to various embodiments, the predetermined classification algorithm includes a multivariate classification algorithm, a support vector machine (SVM) algorithm, a principle component analysis (PCA) algorithm, etc.

As described above, it has been previously assumed that there is only one phenotype in any biological sample 101 or 102. However, in practice, a phenotype in the biological sample 101 or 102 may be classified into one or more groups or collections.

Further, the phenotype analyzing unit 111 calculates distribution ratios of the classified subgroups for each of the biological samples 101 and 102. Techniques for classifying phenotypes and calculating distribution ratios of the subgroups are known in the art.

Next, the process of receiving, performed by the data receiving unit 110, and the results of hybridizing the biological samples A 101 and B 102 with the probes of the micro-arrays A 31 and B 32 from the micro-arrays A 31 and B 32 will be described below in detail.

When the micro-arrays 31 and 32 are contacted with the biological samples 101 and 102 to be analyzed, the micro-arrays 31 and 32 provide results of hybridizing nucleic acids of the biological samples 101 and 102 with the probes of the micro-arrays 31 and 32.

When there is a reaction between the biological samples 101 and 102 and the probes, different degrees of hybridization are presented depending on complementary degrees between the biological samples 101 and 102 and the probe materials. Here, a fluorescent signal is used for estimating the degrees of hybridization. The biological samples 101 and 102 labeled with a fluorescent material are put into reaction with the micro-arrays 31 and 32, and then excitation light is applied to the fluorescent material. Then a fluorescent signal is detected by a light radiated from the fluorescent material. The data receiving unit 110 receives the hybridization results in the form of image data.

The gene expression analyzing unit 112 analyzes gene expression data for each of the biological samples 101 and 102 based on the hybridization results. Furthermore, the gene expression analyzing unit 112 calculates gene expression levels for each of the biological samples 101 and 102 from the analyzed gene expression data.

Specifically, the gene expression analyzing unit 112 obtains the gene expression levels of the biological samples 101 and 102 by converting the intensity of the fluorescence signal in the image data into numerical data, which is then analyzed by the gene expression analyzing unit 112. The process of obtaining the gene expression levels of the biological samples 101 or 102 is apparent to one of ordinary skill in the art and thus a description thereof is omitted.

In other words, the gene expression analyzing unit 112 obtains the gene expression level of the biological sample A 101 from the micro-array A 31 and obtains the gene expression level of the biological sample B 102 from the micro-array B 32.

The profile generating unit 113 generates a gene expression profile using the distribution of the classified subgroups and the analyzed gene expression data. Here, the gene expression profile includes information about how phenotypes corresponding to the classified subgroups affect the obtained gene expression data.

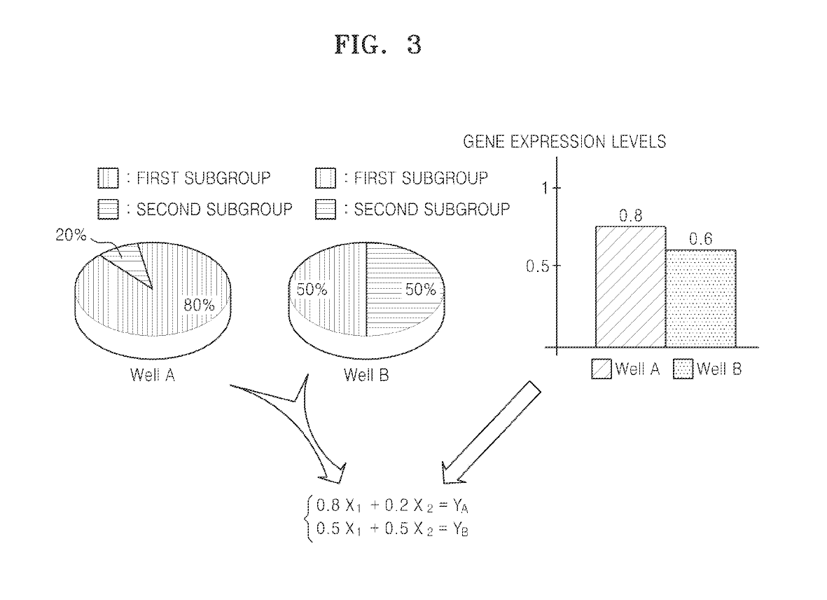

The profile generating unit 113 generates the gene expression profile by statistically estimating the gene expression levels that correspond to the classified subgroups for each of the biological samples. That is, the profile generating unit 113 statistically estimates a correlation of the calculated distribution ratios and the calculated gene expression levels of the biological samples. The process of generating the gene expression profile will be described below in detail with reference to FIG. 3

FIG. 3 shows the process of generating the gene expression profile, according to an embodiment. Referring to FIG. 3, the profile generating unit 113 in FIG. 2 generates the gene expression profile using the distribution ratios of the subgroups analyzed by the phenotype analyzing unit 111 and the gene expression data analyzed by the gene expression analyzing unit 112.

In the example shown in FIG. 3, as a result of analyzing the phenotypes in the biological sample A 101, which is performed by the phenotype analyzing unit 111, a phenotype corresponding to a first subgroup occupies 80% and a phenotype corresponding to a second subgroup occupies 20%. As a result of analyzing the phenotypes in the biological sample B 102, which is performed by the phenotype analyzing unit 111, the phenotype corresponding to the first subgroup occupies 50% and the phenotype corresponding to the second subgroup occupies 50%. In other words, as opposed to the traditional assumption, even though the biological samples 101 and 102 are of the same type, they may be classified into different subgroups of phenotypes. The distribution ratios illustrated in FIG. 3 are merely examples and are not limited thereto.

As a result of analyzing the gene expression level of the biological sample A 101 contained in the well A 21, which is performed by the gene expression analyzing unit 112, the gene expression level has a relative value of 0.8. As a result of analyzing the gene expression level of the biological sample B 102 contained in the well B 22, which is performed by the gene expression analyzing unit 112, the gene expression level has a relative value of 0.6. The numerical values of the gene expression levels illustrated in FIG. 3 are merely examples and are not limited thereto.

Since biological samples 101 and 102 of the same cells and the same tissues have traditionally been assumed to have only one phenotype, in that case, each of the gene expression levels of the biological samples 101 and 102 may be assumed to have a value of 0.7, an average of the gene expression levels of the two biological samples 101 and 102. However, in practice, even the biological samples 101 and 102 of the same cells and the same tissues may be classified into different subgroups of phenotypes, and thus, the traditional assumption does not help to obtain exact gene expression levels of the biological samples 101 and 102.

According to the present embodiment, when the profile generating unit 113 estimates a correlation between the distribution ratios of the subgroups and the gene expression levels, for each of the biological samples 101 and 102, to generate the gene expression profile, the profile generating unit 113 statistically estimates the correlation using the following equations, for example:

0.8X₁+0.2X₂=Y_{A} , and

0.5X₁+0.5X₂=Y_{B}

where the coefficients 0.8, 0.2, 0.5, and 0.5 of X₁ and X₂ refer to distribution ratios of the subgroups. Y_{A} and Y_{B} refer to gene expression levels in the biological samples 101 and 102, respectively. Therefore, in this embodiment, Y_{A} is 0.8 and Y_{B} is 0.6.

X₁ and X₂ refer to effects of the phenotypes that correspond to the classified subgroups on the obtained gene expression data, i.e., weights, for example. In example equations above, X₁ and X₂ are obtained to be X₁=0.933 and X₂=0.266, respectively.

Therefore, for the biological samples 101 and 102, it may be interpreted that the phenotype corresponding to the first subgroup affects the gene expression levels of the biological samples 101 and 102 with 0.933 weights, and the phenotype corresponding to the second subgroup affects the gene expression levels of the biological samples 101 and 102 with 0.266 weights.

As illustrated in FIG. 3, the profile generating unit 113 generates the gene expression profile by statistically estimating the correlation between the distribution ratios of subgroups and the gene expression levels.

In the embodiment, each biological sample 101 or 102 is classified into two subgroups and thus two biological samples 101 and 102 are used. However, in the case where any biological sample is classified into n subgroups, where n is greater than 2, n biological samples should be used.

In the case of generating the gene expression profiles in this manner, for the same types of biological samples as the biological samples 101 and 102, gene expression levels of the samples may be predicted in reverse order if the distribution ratios of subgroups of the phenotypes in the biological samples are known.

For example, when the distribution ratios of the first subgroup and the second subgroup are 30% and 70%, respectively, for phenotypes in the same type of arbitrary biological samples, the gene expression levels may be predicted to be about 0.466 (i.e., determined by calculating: (0.30)(0.933)+(0.70)(0.266)=0.466).

Further, in the case where an arbitrary biological sample reacts with a drug, the drug efficacy corresponding to each of the classified subgroups may be known.

For example, in an experiment of measuring drug efficacy, when measuring gene expression levels while increasing the amount of drug dose, where it is the first subgroup that has a phenotype that affects much the gene expression levels and the second subgroup that has a phenotype that affects less the gene expression levels, one may predict that the phenotype corresponding to the second subgroup relates to this drug efficacy because the phenotype corresponding to the second subgroup turned out to have less gene expression due to the drug efficacy.

Referring again to FIG. 2, the apparatus 10 generates a more exact and efficient gene expression profile by obtaining data associated with phenotypes from the well A 21 and well B 22, obtaining data associated with gene expression from the micro-arrays 31 and 32, and then analyzing the correlation between them.

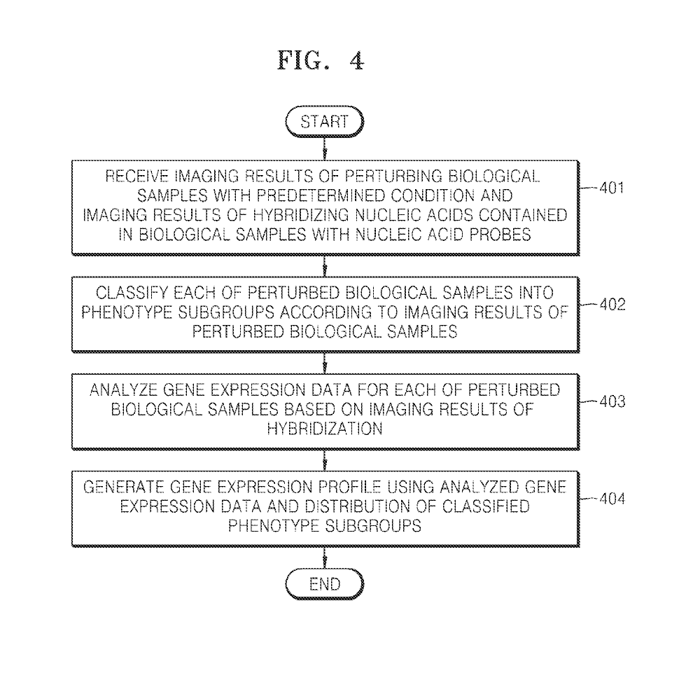

FIG. 4 is a flowchart of a method of generating a gene expression profile, according to an embodiment. Referring to FIG. 4, the method includes operations to be processed chronologically by the apparatus 10 as shown in FIGS. 1 and 2. Thus, the foregoing description about the apparatus 10 also applies to the method of generating a gene expression profile according to the embodiment.

In operation 401, the data receiving unit 110 receives results of perturbing biological samples under a predetermined condition and results of hybridizing the biological samples with the probes.

In operation 402, the phenotype analyzing unit 111 classifies each of the phenotypes in the biological samples into at least one subgroup according to the perturbed results received.

In operation 403, the gene expression analyzing unit 112 analyzes gene expression data for each of the biological samples 101 and 102 based on the hybridization results.

In operation 404, the profile generating unit 113 generates the gene expression profile using a distribution of the classified subgroups and the analyzed gene expression data.

As such, a more exact and efficient gene expression profile may be obtained by classifying a phenotype in a biological sample into subgroups in advance according to predetermined criteria and generating a gene expression profile of the biological sample based on the classified subgroups.

For example, when one is seeking a target to develop a new medicine, he/she may find a more exact target biomarker for the new medicine with the gene expression profile generated as described above. Furthermore, when testing the newly developed medicine in vitro, a more exact efficacy and toxicity of the medicine to cells may be predicted, thus building a more exact database of gene expression profiles for cells, tissues, etc.

In addition, other embodiments of the present invention can also be implemented through computer-readable code/instructions in/on a medium, e.g., a non-transitory computer-readable medium, to control at least one processing element to implement any embodiment described above. The computer-readable medium can correspond to any medium/media permitting the storage and/or transmission of the computer-readable code.

The computer-readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media. Thus, the medium may be such a defined and measurable structure including or carrying a signal or information, such as a device carrying a bitstream according to one or more embodiments of the present invention. The media may also be a distributed network, so that the computer-readable code is stored/transferred and executed in a distributed fashion. Furthermore, the processing element could include a processor or a computer processor, and processing elements may be distributed and/or included in a single device.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A method of generating a gene expression profile, the method comprising:
receiving imaging results of perturbing biological samples with a predetermined condition and imaging results of hybridizing nucleic acids contained in the biological samples with nucleic acid probes;
classifying each of the perturbed biological samples into phenotype subgroups according to the imaging results of the perturbed biological samples;
analyzing gene expression data for each of the perturbed biological samples based on the imaging results of the hybridization; and
generating a gene expression profile using the analyzed gene expression data and a distribution of the classified phenotype subgroups.

2. The method of claim 1, wherein the gene expression profile comprises information about how the phenotypes corresponding to the classified phenotype subgroups affect the gene expression data.

3. The method of claim 1, wherein the generating of the gene expression profile comprises statistically estimating gene expression levels that correspond to the classified phenotype subgroups for each of the biological samples.

4. The method of claim 3, further comprising:
calculating distribution ratios of the classified phenotype subgroups for each of the biological samples;
calculating the gene expression levels from the analyzed gene expression data for each of the biological samples; and
estimating a correlation between the distribution ratios and the gene expression levels for the biological samples,
wherein the generating of the gene expression profile is based on the estimated correlation.

5. The method of claim 1, wherein the imaging results of the hybridization include results of hybridizing the nucleic acids of the biological samples with probes by contacting the nucleic acids of the biological sample with a microarray containing the probes.

6. The method of claim 1, wherein the biological samples include multiple samples for a cell of a same type.

7. The method of claim 1, wherein the classifying each of the phenotypes comprises applying a predetermined classification algorithm to each of the imaging results of the perturbed biological samples.

8. The method of claim 7, wherein the imaging results of the perturbed biological samples are based on image data obtained by using High Content Cell Imaging.

9. The method of claim 8, wherein the imaging results of the perturbed biological samples include light intensities of fluorescent materials used to label the perturbed biological samples.

10. A non-transitory computer-readable medium having a computer executable program stored thereon for carrying out the method of claim 1.

11. An apparatus for generating a gene expression profile, the apparatus comprising:
a data receiving unit for receiving imaging results of perturbed biological samples using a predetermined condition and receiving imaging results of hybridizing nucleic acids in the biological samples with nucleic acid probes;
a phenotype analyzing unit for classifying the perturbed biological samples into phenotype subgroups according to the imaging results of the perturbed biological samples;
a gene expression analyzing unit for analyzing gene expression data for each of the biological samples based on the imaging results of the hybridization; and
a profile generating unit for generating a gene expression profile using the analyzed gene expression data and a distribution of the classified phenotype subgroups.

12. The apparatus of claim 11, wherein the generated gene expression profile comprises information about how the phenotypes corresponding to the classified phenotype subgroups affect the gene expression data.

13. The apparatus of claim 11, wherein the profile generating unit generates the gene expression profile by statistically estimating gene expression levels that correspond to the classified phenotype subgroups for each of the biological samples.

14. The apparatus of claim 13, wherein the phenotype analyzing unit calculates distribution ratios of the classified phenotype subgroups for each of the biological samples,
wherein the gene expression analyzing unit calculates the gene expression levels from the analyzed gene expression data for each of the biological samples, and
wherein the profile generating unit generates the gene expression profile by statistically estimating a correlation between the distribution ratios and the gene expression levels for the biological samples.

15. The apparatus of claim 11, wherein the imaging results of the hybridization are received from micro-arrays containing the probes.

16. The apparatus of claim 11, wherein the biological samples include multiple samples comprising the same type of cell.

17. The apparatus of claim 11, wherein the phenotype analyzing unit classifies the phenotypes into the phenotype subgroups by applying a predetermined classification algorithm to each of the received imaging results of the perturbed biological samples.

18. The apparatus of claim 17, wherein the received imaging results of the perturbed biological samples are based on image data obtained using High Content Cell Imaging.

19. The apparatus of claim 18, wherein the received imaging results of the perturbed biological samples are light intensities of fluorescent materials used to label the perturbed biological samples.

20. A method of generating a gene expression profile, the method comprising:
perturbing biological samples with a predetermined condition and imaging the perturbed biological sample;
hybridizing nucleic acids contained in the biological samples with nucleic acid probes;
classifying the perturbed biological samples into phenotype subgroups according to the imaging results of the perturbed biological samples;
analyzing gene expression data of the perturbed biological samples based on the hybridization of the nucleic acids of biological samples with the probes; and
generating a gene expression profile using the analyzed gene expression data and a distribution of the classified subgroups.
